(19) United States
(12) Patent Application Publication
(10) Pub. No.: US 2006/0248239 A1
(43) Pub. Date: Nov. 2, 2006

(54) Data Processing System Capable of Running Two Modes Independently and Exclusively

(76) Inventors: Wen-Chin Lee, Taipei City (TW); Chih-Sheng Huang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/161,785

(22) Filed: Aug. 16, 2005

(30) Foreign Application Priority Data
Apr. 27, 2005 (TW) 094113461

(51) Int. Cl. G06F 3/00

(52) U.S. Cl. 710/14; 711/154

(57) ABSTRACT

A data processing system includes a storage device which stores data, a processor which processes application programs and generates decision signals, a bus switch which is coupled with the storage device and the processor, and a processing chip which is coupled with the bus switch, the storage device, and the processor. The data processing system takes advantage of functions of playing media and processing application programs, wherein the functions are designed together with the processing chip. It is more powerful for combining both the functions to increase efficiency of the processor than general data processing system.

### BACKGROUND OF THE INVENTION

1. Field of the Invention

The claimed invention provides a data processing system, particularly, a data processing system capable of operating in two different modes independently and exclusively.

2. Description of the Prior Art

Most Global Positioning Systems (GPS) stores maps on a hard disk (HD). Maps belonging to various areas must be stored by GPS so that users are able to look up the maps for where they are at anytime. As a result, the amount of stored maps is often very large. Therefore such combinative systems of GPS and HD must be large in disk space.

Taking GPS as it is disposed in domestic vehicles as an example, if the disk space of the GPS system is too large, the cost of production will significantly increase. More seriously, the design of domestic vehicles will be affected. The above reasons result in an extreme decrease in the practicability of GPS to be disposed in domestic vehicles.

Secondly, because of the large difference between the spheres of activities of most users, each user's essential maps are often different. Moreover, since the essential maps of most users take up a small percentage of the considerable number of maps stored on the HD, and a large percentage of the stored maps are rarely used by users, efficient usage of storage space is difficult. In view of the price of storage space on the HD, as well as the lack of usage of the stored maps, storing all the maps needed by GPS on the HD is a waste of space, at a high cost of usage.

### SUMMARY OF THE INVENTION

Therefore, the present invention provides a data processing system capable of operating in two different modes independently and exclusively to solve the aforementioned problems.

The data processing system comprises a storage device for storing data, a processor for processing application programs and generating decision signals, a bus switch coupled to the storage device and the processor, and a processing chip coupled to the bus switch, the storage device and the processor. The processing chip is capable of ordering the bus switch to establish a connection enabling the processing chip to transmit control signals to the storage device, or a connection enabling the processing chip to transmit control signals to the processor according to a decision signal generated by the processor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of the data processing system of the embodiment.

FIG. 2 is a diagram of the decision circuit in FIG. 1.

### DETAILED DESCRIPTION

The present invention replaces the prior art's method of combining GPS and HD by a method of combining a Digital Video Disc Player (DVD-Player) and Motion Pictures Expert Group (MPEG) chips to reach a specific effect of economizing the amount of disk space used and using the disk space more efficiently.

The embodiment of the present invention uses an MPEG chip called M3355. While designing the MPEG chip, the respective functions of MPEG and Servo are preserved; which allows for the combination of the MPEG chip and DVD-Player as a specific embodiment of the present invention, to replace the combination of GPS and HD.

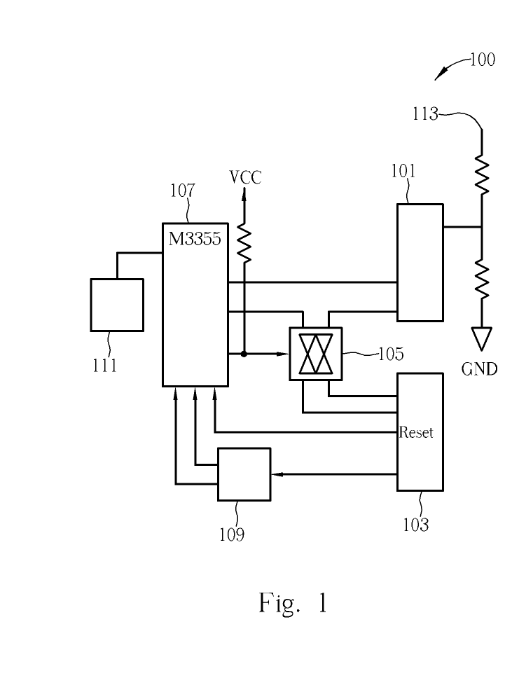

Please refer to FIG. 1, which is a diagram of the data processing system 100 of the embodiment. Data processing system 100 comprises a storage device 101, a processor 103, a bus switch 105, a processing chip 107, a decision circuit 109, and a media loader 111, which has its own storage device. The storage device 101 stores needed programs during the operation of the data processing system 100. The processor 103 processes application programs and generates decision signals. The processing chip 107 is coupled with the bus switch 105, the storage device 101, and the processor 103. The processing chip 107 directs the bus switch 105 to establish a connection enabling the processing chip 107 to transmit control signals to the storage device 101 or a connection enabling the processing chip 107 to transmit control signals to the processor 103 according a decision signal generated by the processor 103. The decision circuit 109 transmits the decision signal generated by the processor 103 to the processing chip 107. The media loader 111 transmits the data stored by the storage device inside the media loader 111 to the processing chip 107, where the transmitted data could be media data or application programs, including GPS. Furthermore, when the storage device 101 receives a the control signal generated by the processing chip 107, an enabling switch 113 belonging to the storage device 101 is enabled for the stored programs in the storage device 101 to be transmitted to the processing chip 107. When the enabling switch 113 is disabled, the storage device 101 stops transmitting programs to the processing chip 107.

The data processing system 100 controls the bus switch 105 to establish two connections according to a decision signal generated by the processor 103. One connection is for the processing chip 107 to transmit control signals to the storage device 101, where the connection is operated under an operation mode called “Servo Only” mode, which is run for executing application programs, including GPS. Another connection is for the processing chip 107 to transmit control signals to the processor 103, and the connection to be operated under an operation mode called “Combo” mode or “DVD-Player” mode, which is used for playing media data. Both the connections are independent of each other and exclusive, and they cannot happen at the same time through control of the bus switch 105.

When the data processing system 100 is booted from its initialization state, the enabling switch 113 of the storage device 101 is enabled for the storage device 101 to transmit core programs of Servo Only mode and Combo mode to the processing chip 107. After the processing chip transmits all the core programs, the enabling switch 113 of the storage device 101 is disabled so that the storage device 101 is not able to continue transmitting programs to the processing chip 107.

During the initialization state, the purpose of the data processing system 100 is to transmit the core programs with high frequency of usage from the storage device 101 to reside in the processing chip 107 so that the processing chip 107 can save additional time by not having to continually request them from the storage device 101.

When the data processing system 100 is going to be in Combo mode, the processor 103 transmits a decision signal belonging to Combo mode through the decision circuit 109 to the processing chip 107. Then the processing chip 107 orders the bus switch 105 to establish a connection enabling the processing chip 107 to transmit a control signal to the storage device 101 so that the processing chip 107 is capable of transmitting a request signal to the storage device 101. According to the request signal generated by the processing chip 107, the enabling switch 113 is enabled, and the storage device 101 is allowed to transmit other programs of Combo mode needed by the processing chip 107. Lastly, the processing chip 107 loads the media data stored in the storage device into the media loader 111 and processes the media data according to the programs transmitted from the storage device 101 until a decision signal, which gives an order to switch the data processing system 100 from Combo mode to Servo Only mode, is transmitted from the processor 103. When the data processing system 100 is switched from Combo mode to Servo Only mode, the enabling switch 113 of the storage device 101 is disabled by grounding so that no more programs are transmitted from the storage device 101 to the processing chip 107. At the same time, the processor 103 transmits a decision signal belonging to Servo Only mode to the processing chip 107 through the decision circuit 109 so that the processing chip 107 will transmit a control signal to the bus switch 105. After receiving the control signal, the bus switch 105 disconnects the connection enabling the processing chip 107 to transmit request signals to the storage device 101 and establishes a connection enabling the processing chip 107 to transmit data to the processor 103.

When the data processing system 100 is going to be in Servo Only mode, the processor 103 transmits a decision signal, belonging to the Servo Only mode, to the processing chip 107. Then the processing chip 107 transmits a control signal ordering the bus switch 105 to establish a connection enabling the processing chip 107 to transmit data to the processor 103 so that the processing chip 107 is capable of transmitting messages to the processor 103 or transmit application programs through the connection to the processor 103 to assist Servo Only mode. The processing chip simultaneously loads application programs stored in the storage device inside the media loader 111 and transmits the application programs to the processor 103, so that the processor 103 is capable of executing the transmitted application programs. When the data processing system 100 is switched from Servo Only mode to Combo mode, the processor 103 transmits a decision signal belonging to Combo mode to the processing chip 107 so that the processing chip 107 transmits a control signal to the bus switch 105; after receiving the control signal, the bus switch 105 disconnects the connection enabling the processing chip 107 to transmit data to the processor 103 and establishes a connection enabling the processing chip 107 to transmit request signals to the storage device 101.

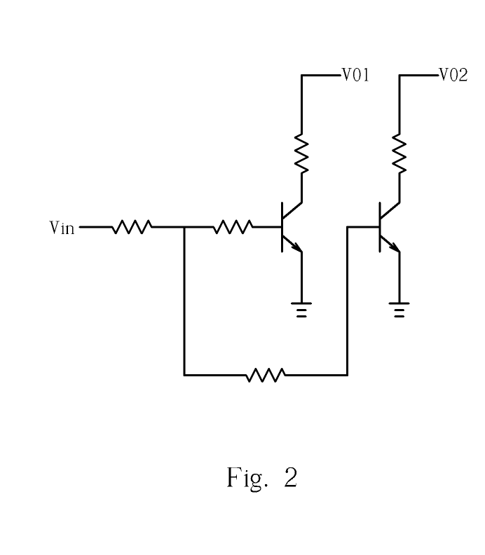

Please refer to FIG. 2, which is a diagram of the decision circuit 109 in FIG. 1. The decision circuit 109 outputs a signal from one of the outputs V₀₁ and V₀₂ to the processing chip 107 according to the decision signal Vᵢₙ transmitted from the processor 103, wherein the outputs V₀₁ and V₀₂ correspond to Servo only mode and Combo mode or Combo mode and Servo Only mode respectively.

By using a DVD-Player, maps can be stored in different DVDs according to varying types of activities and varying purposes of users. With the convenience of changing DVDs in DVD Players, the storage space of maps decreases significantly and the efficiency of stored map usage increases. Moreover, in addition to serving as GPS hardware, the embodiment can also play media data directly so that it is capable of providing entertainment, which increases its practicality. The presentation of maps is not the only program that can be put on DVD; personal data can, too. In the method of combining GPS and HD, most space of HD is used to store huge amounts of map data, such that surplus space is too rare to store other media data. The combination of DVD-Player and MPEG chip of the present invention is more versatile than the method of combining GPS and HD.

The embodiment of the present invention preserves function of the processing chip because Combo mode (which plays media data) and Servo Only mode (which executes application programs) are both capable of being operated inside the same processing chip independently and exclusively by way of switching the bus switch. Therefore it is more frugal with hardware usage than the prior art's method of operating the two modes in different chips and systems. Furthermore, because of independent and exclusive operations of both modes, the efficiency of the processing chip will not decrease by combining both modes in the same processing chip.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A data processing system capable of running two modes independently and exclusively, the data processing system comprising:
a storage device for storing data;
a processor for processing application programs and generating decision signals;
a bus switch coupled with the storage device and the processor; and
a processing chip coupled with the bus switch, the storage device and the processor, wherein the processing chip is capable of ordering the bus switch to establish a connection enabling the processing chip to transmit control signals to the storage device or a connection enabling the processing chip to transmit control signals to the processor according to a decision signal generated by the processor.

2. The data processing system of claim 1 further comprising a media loader coupled with the processing chip for loading stored data of the storage device into the media loader.

3. The data processing system of claim 2, wherein the processing chip comprises a servo unit for processing application programs transmitted from the media loader.

4. The data processing system of claim 3, wherein the storage device stores a set of servo programs to operate the servo unit.

5. The data processing system of claim 2, wherein the storage device stores a set of media decompressing programs to decompress media data transmitted from the media loader.

6. The data processing system of claim 1, wherein the storage device comprises an enabling switch for transmitting the stored data of the storage device to the processing chip when the enabling switch is enabled.
